(19) United States
(12) Patent Application Publication
(10) Pub. No.: US 2003/0039809 A1
(43) Pub. Date: Feb. 27, 2003

(54) Surface decoration having a 3-dimesional effect and method for producing same

(76) Inventor: Harald Johnsen, Oslo (NO)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/221,408

(22) PCT Filed: Mar. 15, 2001
(86) PCT No.: PCT/NO01/00110

(30) Foreign Application Priority Data
Mar. 16, 2000 (NO) 20001390

(51) Int. Cl. B32B 3/00

(52) U.S. Cl. 428/195

(57) ABSTRACT

A surface decoration having a 3-dimensional effect, for placement on a surface, comprising a transparent carrier sheet of film (1), with a first side (2) to face the surface and a second side (3) to face away from the surface. A printed design (4) is applied in mirror image on image on the first side (2), at least one object illustration being formed by the printed design (4). A non-transparent body colour print (5) or cover sheet is printed or placed on the printed design (4). The object illustration is formed by a part (6b) of the printed design (4) falling outside of the body colour print (5) or cover sheet and the printed design (4) is transparent in the shaded depiction. A method of producing the surface decoration is also described.

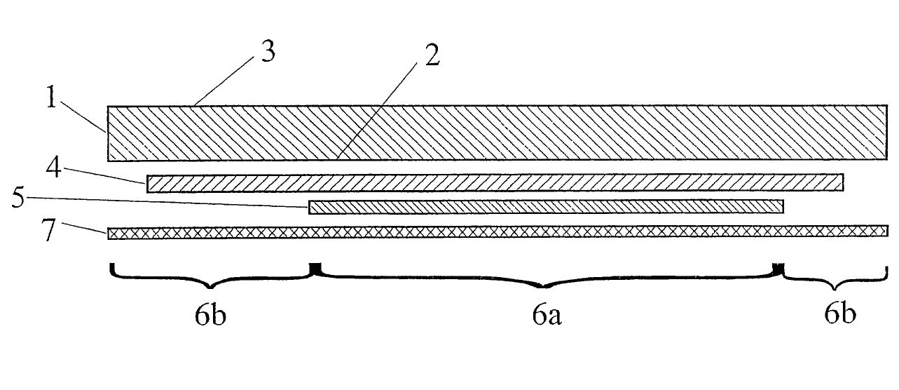

The present invention relates to a surface decoration having a 3-dimensional effect, for placement on a surface, according to the preamble of claim 1, and a method for producing a surface decoration having a 3-dimensional effect according to the preamble of claim 6.

The invention further relates to a method of producing a surface decoration having a 3-dimensional effect, comprising an object illustration formed by a monochrome or multicoloured transparent printed design.

It is known to apply decorations, for example in the form of a company emblem or an advertisement, to various kinds of surfaces. Accordingly, it is also known to apply such decorations to the floor. Numerous attempts have been made to achieve a surface decoration with a 3-dimensional effect, i.e. a picture of an object that gives an impression of being a real object. The best example of a 3-dimentional surface decoration of this kind is shown in European patent application 812.707, of the same inventor as in the present application.

This application shows a surface decoration in which a 3-dimensional effect is achieved by creating an artificial shadow of the object pictured on the decoration. The surface, e.g., the floor, can be seen through the “shadow”, since the shadow is created by printing with transparent colours on a transparent sheet of film. Beneath the object print, however, a body colour or cover sheet is placed, to make the object opaque. The shadow is created by the part of the transparent print falling outside of the body colour or cover sheet.

Although this surface decoration has been very successful in the market, and at the time is superior to any other surface decoration with a 3-dimensional effect, the present inventor has found a way to improve this decoration.

The decoration of EP 812.707 comprises two sheets of transparent film. The print is placed on top of the first sheet and a second sheet is placed on top of the print to protect the print from damages. Without this protective sheet the print would very soon wear off, if placed, e.g., as an advertisement on a floor of a mall.

However, the protective sheet blurs the view to the object shadow and floor, makes the decoration thicker, creates reflex problems, and makes the boundaries of the decoration (i.e. the sheets) more visible. All this diminishes the 3-dimensional effect. Besides, it adds costs to the decoration.

The aim of the present invention is to improve the 3-dimensional effect of such a surface decoration. This is achieved by printing the design in mirror image on the bottom surface, i.e. the surface facing the floor, of the carrier sheet. Thus, the carrier sheet will get a double function, acting both as a carrier for the print and as a protective sheet. The printed design will be situated closely to the surface, with only one layer of transparent sheet above.

The invention will now be described in more detail with reference to the accompanying figure showing a cross section through the layers of the decoration.

The decoration shown in the figure consists of a carrier sheet 1, with a first side 2, to face the surface on which the decoration is to be placed, and a second side 3, to face away from the surface, a printed design 4 on the first side of the sheet 1, a printed body colour or cover sheet 5, provided on the printed design, and a layer of glue 7, provided on the printed design, body colour or cover sheet.

In producing the decoration, one first provides the transparent carrier sheet of film 1. To the first side of the transparent carrier sheet 1, over at least a portion of the surface thereof, is applied a print 4, which is to form an object illustration. On a part of this print 4 a body colour (opaque pigment) 5, or a cover sheet of film is applied. The body colour or the cover sheet is non-transparent. The body colour 5 should be light in colour, and preferably white. This is to avoid giving an undesirable colour cast to the decorating colours of the print 4. The body colour 5 is applied on only a section 6a of the print 4, while on another section 6b of the carrier sheet 1, no body colour or cover sheet has been applied.

In the section 6b the print 4 forms a shaded depiction, which is to give the impression of a “shadow” from the object in the object illustration, i.e. section 6a. The shadow in section 6b may me on both sides of section 6a, as shown, or on one side only, depending on how the outline of a natural shadow would have been. Finally, the layer of glue 7 is applied over sections 6a and 6b.

Now the decoration can be applied to a surface that is to be decorated, such as a wall or a floor. Although not show, it is conceivable that a section of the carrier sheet 1 may not be coated with either a body colour/cover sheet or a decorating colour. However, it is preferable to cut the carrier sheet 1 into the same shape as the print 4.

In section 6a, the decorating colours will be seen without the floor showing through them, and produce an illustration of an object with a complete coverage of saturated colours. In section 6b the decorating colours 4 will also be visible, but in this case the floor will show through the transparent decorating colours 4, and a dark print in this part will give the impression that the object in the object illustration is casting a shadow on the floor.

To obtain a partial translucent visibility of the floor, the body colour (opaque pigment) over portions of the decoration may be thinned or toned down with a saturation in the range of from 0 to 100%. This can be accomplished by, for example, using a screen in printing the body colour. In this manner, by printing the decorating colours in a screen corresponding to the screen used for the body colour, it is possible to create an illusion of; for example, sand being strewn over a floor.

The glue in the glue layer 7 is preferably of a non-permanent type, permitting removal of the decoration. This is particularly important when the decoration is an advertisement, which is likely to be changed frequently.

The body colour or opaque pigment, and/or the decorating colours, is (are) preferably applied by means of electrostatic printing, but may also be produced by silk screening. The decorating colours preferably comprise 4-color prints, but if desired the decoration may also be printed in fewer colours, or even in shades of grey.

1. A surface decoration having a 3-dimensional effect, for placement on a surface, comprising a transparent carrier sheet of film (1), with a first side (2) to face the surface and a second side (3) to face away from the surface, a printed design (4) on at least a portion of the carrier sheet (1), at least one object illustration formed by the printed design (4) and a non-transparent body colour print (5) or cover sheet, wherein a shaded depiction of the object illustration is formed by a part (6b) of the printed design (4) falling outside of the body colour print (5) or cover sheet, the printed design (4) being transparent in the shaded depiction, characterized in that the printed design (4) is printed in mirror image on the first side (2) of the carrier sheet (1) and that the body colour (5) or cover sheet is printed or placed on the printed design (4).

2. A decoration in accordance with claim 1, characterized in that a layer of glue (7) is provided on the printed design (4) and the body colour (5) or cover sheet.

3. A decoration in accordance with claims 1 or 2, characterized in that the body colour (opaque pigment) (5) and/or the cover sheet of film are light in colour, preferably white.

4. A decoration in accordance with any one of the claims 1-3, characterized in that the body colour (5) is thinned or toned down over at least a portion of the decoration so as to render it partially transparent, e.g., by printing the body colour (5) in a screen.

5. A decoration in accordance with any one of the claims 1-4, characterized in that the second side (3) of the transparent sheet is corrugated.

6. A method of producing a surface decoration having a 3-dimensional effect, comprising an object illustration formed by a monochrome or multicoloured transparent printed design (4), where said printed design (4) is applied on a transparent carrier sheet of film (1) and a body colour print (opaque pigment) (5) or a non-transparent film sheet is applied over a portion of the printed design (4), characterized in that the printed design is applied in mirror image on a first side of the transparent carrier sheet of film (1) and the body colour (5) or cover sheet is arranged to coincide with a first surface area (6a) corresponding with the object illustration and leaving a second surface area of the printed design without body colour (5) or cover sheet, said second surface area corresponding with a shaded depiction of the object illustration.

7. A method in accordance with claim 6, characterized in that, over at least a portion of the decoration, the body colour (5) is applied as a thinned or toned down, and thereby partially transparent, body colour (5), e.g., by printing the body colour (3) in a screen.

8. A method in accordance with claim 6 or 7, characterized in that a layer of glue is applied over the printed design and the body colour or cover sheet.
